(19) United States
(12) Patent Application Publication
(10) Pub. No.: US 2009/0161482 A1
(43) Pub. Date: Jun. 25, 2009

(54) MIXING DEVICE CONFIGURED TO MIX FOODSTUFF

(75) Inventor: Michael Sandford, Chester, VA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HAMILTON BEACH BRANDS, INC., Glen Allen, VA (US)

(21) Appl. No.: 11/962,325

(22) Filed: Dec. 21, 2007

(51) Int. Cl. B01F 7/00; B01F 15/02

(52) U.S. Cl. 366/192; 366/197; 366/205

(57) ABSTRACT

A mixing device for mix foodstuff includes a base housing at least one motor. The mixing device further includes a jar for containing the foodstuff. The mixing device has a first operating configuration wherein the foodstuff is blended within the jar. The mixing device includes at least one travel mug for containing the foodstuff. The mixing device has a second operating configuration wherein the foodstuff is mixed within the at least one travel mug. The jar and the at least one travel mug are separately removably mountable to the base. The at least one travel mug is removably mountable within the jar for storage.

### BACKGROUND OF THE INVENTION

The present application is directed to a mixing device configured to mix, process or blend foodstuff and, more particularly, to a mixing device, blender or other such kitchen appliance that includes a jar for containing foodstuff and at least one travel mug for containing foodstuff, wherein the jar and the at least one travel mug are separately removably mountable to the base for blending and storage purposes.

Mixing devices or blenders are a relatively common household or kitchen appliance that are used to blend foodstuff, typically drinks or other foodstuff that is blended into a semi-fluid state. A typical blender includes a base enclosing a motor, a jar removably mounted to the base for containing the foodstuff and a lid to enclose the foodstuff within the jar. More recently, it has become popular to provide jars of various size and shape to accommodate a users needs in blending a variety of foodstuff. For example, certain blender bases, as seen in the food services industry, accommodate relatively large jars to blend large amounts of foodstuff at one time. Other types of blenders bases accommodate relatively small or portable containers or cups, such as a travel mug, to blend smaller amounts of foodstuff for individual or portable use. However, problems arise when the size and shape of the jar makes it difficult to efficiently and evenly blend foodstuff within the jar. For example, because of the relatively large or odd shapes of blending jars, unblended or partially blended foodstuff may become lodged or trapped in a part of the jar separate from the blending blades within the jar. Thus, the foodstuff within the jar may either be unevenly blended or hardly blended at all.

Therefore, it would be desirable to create a blender having two separate and independent motors that may operatively engage two separate and independent sets of blending blades within the interior of the jar of the blender to assure that all of the foodstuff within the blender is evenly and quickly blended. It would be desirable to create an interior surface of the jar that maintains a quantity of foodstuff over the set or sets of blending blades and that urges blended foodstuff towards a dispensing spout of a jar to improve evacuation of blended foodstuff from within the jar. Further, it would be desirable that the two independent and separate motors are capable of being controlled by the actuation of just one control knob on the outer surface of the blender base.

Another problem with conventional blenders is that users must purchase a number of different blender bases to accommodate the various sizes and shapes of jars. Therefore, it would be desirable to create a blender having a base that may operatively engage a variety of different sized and shaped jars such that a user would only need to purchase one blender base for use with a variety of different blender jars. It would be advantageous if smaller sized jars could fit within larger sized jars when the blender is not in use to reduce the overall size of the blender for storage purposes. Further, it would be desirable if the universal blending base included a mechanism to detect or recognize a specific type of jar. For example, if a user decided to use a relatively large jar, it would be desirable that the universal base could recognize that a large jar is in use such that both of the motors within the base would be actuated by just a single control knob when the mechanism detects the specific or particular type of jar on the base of the blender.

### BRIEF SUMMARY OF THE INVENTION

Briefly stated, the present invention is directed to a mixing device configured to blend foodstuff. The device includes a base housing at least one motor and a jar for containing the foodstuff. The device has a first operating configuration wherein the foodstuff is blended within the jar. The device further includes at least one travel mug for containing the foodstuff. The device has a second operating configuration wherein the foodstuff is mixed within the at least one travel mug. The jar and the at least one travel mug are separately removably mountable to the base. The at least one travel mug is removably mountable within the jar for storage.

In another aspect, the present invention is directed to a mixing device configured to blend foodstuff. The device includes a base having first and second motors capable of being separately operable by first and second control knobs, respectively. The base further includes a jar sensor. The device further includes a jar removably mountable to the base for containing the foodstuff. The jar sensor detects a presence of the jar on the base to enable actuation of each of the motors with the input of either the first control knob or the second control knob.

In yet another aspect, the present invention is directed to a mixing device configured to blend foodstuff. The device includes a base housing a first and a second motor. A jar for containing the foodstuff has a first set of blending blades and a second set of blending blades spaced apart from said first set of blending blades within an interior of the jar to blend the foodstuff. The first set of blending blades are operatively connected to the first motor and the second set of blending blades are operatively connected to the second motor when the jar is mounted to the base. A ramp is positioned between the first and second set of blending blades within the interior of the jar to maintain a quantity of foodstuff over the first and second set of blending blades.

### BRIEF DESCRIPTION OF THE SEVERAL VIEWS OF THE DRAWINGS

The foregoing summary, as well as the following detailed description of a preferred embodiment of the present invention, will be better understood when read in conjunction with the appended drawings. For the purpose of illustrating the invention described in the present application, there is shown in the drawings, an embodiment which is presently preferred. It should be understood, however, that the invention is not limited to the precise arrangements and instrumentalities shown. In the drawings:

FIG. 1 is a front right perspective view of a preferred embodiment of a mixing device in accordance with the present invention in a storage configuration;

FIG. 2 is a front right perspective view of the mixing device shown in FIG. 1 in a first operating configuration;

FIG. 3 is a front right perspective view of the mixing device shown in FIG. 1 in a second operating configuration;

FIG. 4 is a front right perspective view of a base of the mixing device shown in FIG. 1;

FIG. 5 is a front right perspective view of a jar of the mixing device shown in FIG. 1;

FIG. 6 is an enlarged perspective view of a dispensing spout of the mixing device shown in FIG. 1 with a dispensing handle in a closed position;

FIG. 7 is an enlarged perspective view of the dispensing spout of the mixing device shown in FIG. 1 with the dispensing handle in an open position; and

FIG. 8 is a cross-sectional elevation view of the jar of the mixing device shown in FIG. 1.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of the mixing device and designated parts thereof. The terminology includes the above-listed words, derivatives thereof and words of similar import.

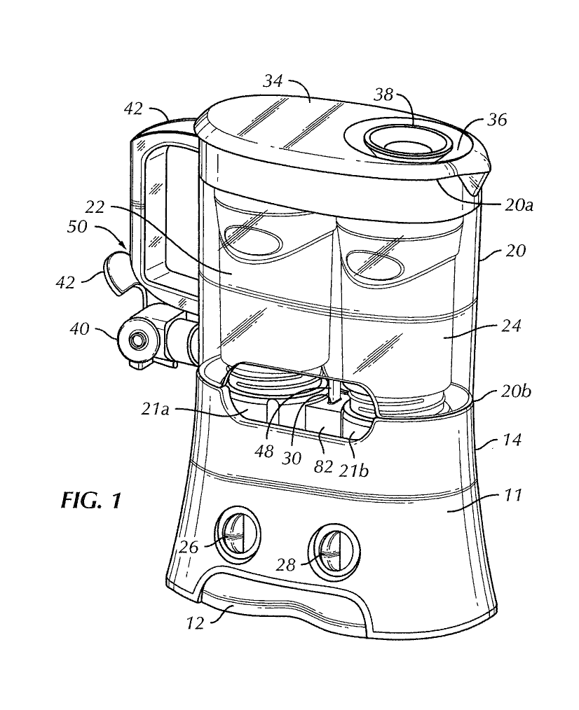

Referring to the drawings in detail, wherein like numerals are used to indicate like elements throughout, there is shown in FIGS. 1-8 a preferred embodiment of a mixing device, generally designated 10, configured to mix or blend foodstuff (not shown). The mixing device 10 is preferably in the form of a conventional kitchen blender, but could be other products such as a food processor, an ice cream machine or a smoothie machine without departing from the spirit and scope of the present invention.

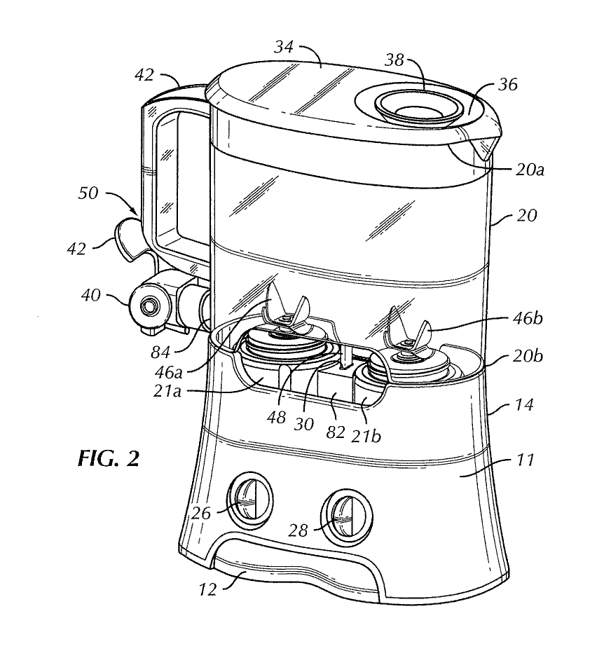

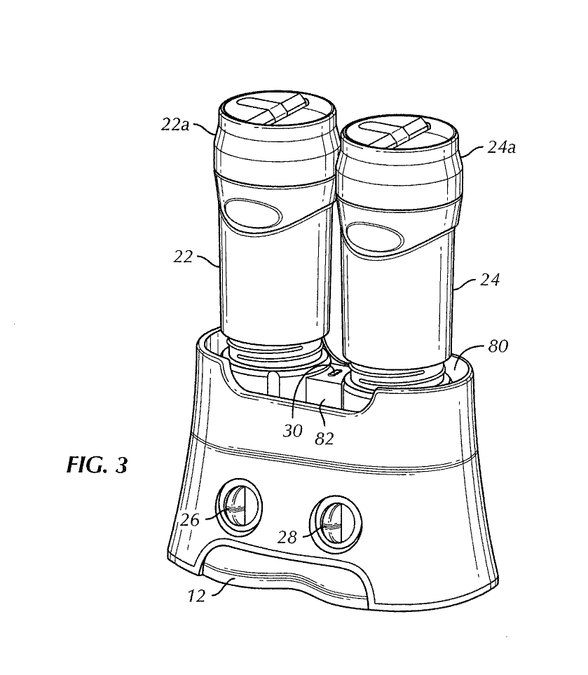

The mixing device 10 has a first operating configuration (FIG. 2) wherein the foodstuff is blended directly within a relatively large jar 20 and a second operating configuration (FIG. 3) wherein the foodstuff is blended directly within at least one relatively small container 22, 24. The jar 20 is preferably in the form of a conventional blender jar, but could be other products such as a pitcher, bucket, barrel or any other container used to hold liquid or blended foodstuff. The at least one smaller container 22, 24 is preferably in the form of a conventional travel mug or travel cup, but could be other products such as a portable coffee cup, a water bottle, a sports bottle or any other container used to hold liquid or blended foodstuff. The jar 20 and the at least one travel mug 22, 24 are separately removably mountable to the base 14. The at least one travel mug 22, 24 is removably mountable within the jar 20 (see FIG. 1) for storage purposes.

As seen in FIGS. 1-4 the mixing device 10 includes a base 14 enclosing at least one motor 16, 18. The base 14 has an outer generally curved housing 11 which is preferably formed of a high strength, lightweight material, such as a polymeric material. The outer housing 11 and at least one motor 16, 18 are supported on a support surface, such as a countertop or table top (not shown), by a base support 12. The base support 12 also supports other operational elements of the mixing device 10 that are well understood by those of ordinary skill in the art. The base 14 may include vent openings (not shown) to expel heat produced within the base 14 and an electrical cord (not shown) for providing power to the at least one motor 16, 18.

Preferably, the at least one motor 16, 18 is comprised of a first motor 16 and a second motor 18 capable of being separately operable by a first control knob 26 and a second control knob 28. However, it is understood by those skilled in the art that the mixing device 10 may include more than two motors without departing from the spirit and scope of the present invention. The first and second control knobs 26, 28, which are conventional control knobs as known to those skilled in the art, extend beyond the outer housing 11 of the base 14 and allow the user to control the operation and speed of the first and second motors 16, 18. The base support 12 may include a series of feet (not shown) comprised of an elastomeric or other non-skid, shock absorbing material for providing stability to the mixing device.

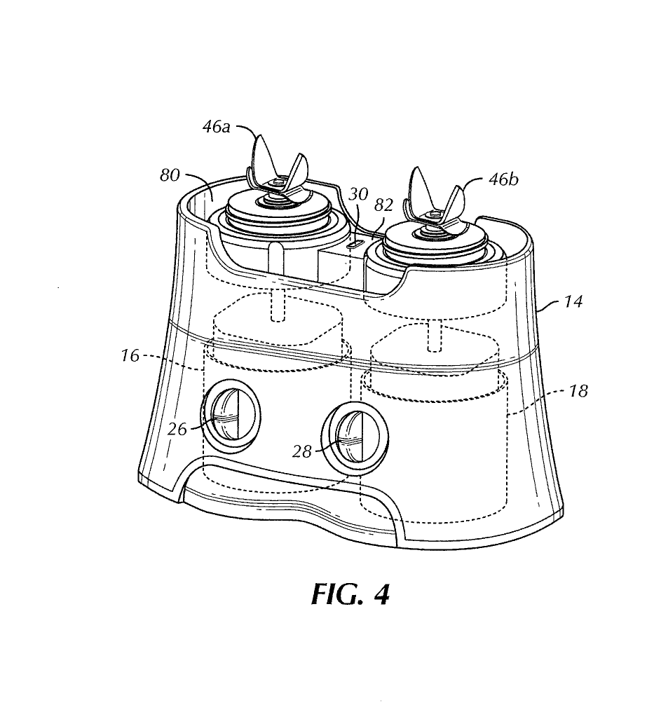

The base 14 includes a generally ovular recessed area 80 in a top surface to receive and operatively engage the jar 20 and/or the at least one travel mug 22, 24. As seen in FIG. 4, the first and second motors 16, 18 are vertically oriented such that a drive shaft of each motor 16, 18 is operatively connected to a base clutch (not shown) located within the recessed area 80 of the base 14. Specifically, the base clutches, which are conventional clutches as known to those skilled in the art, are positioned in the recessed area 80 and are operatively engaged with the drive shafts of the respective first and second motors 16, 18. A raised extension or portion 82 is located within the recessed area 80 of the base 14 to effectively separate the recessed area 80 into two halves. The base 14 includes a jar sensor 30 located within or on the raised area 82 to detect the presence of the jar 20 in the first operating configuration (FIG. 2). The jar sensor 30 detects a presence of the jar 20 on the base 14 enable actuation of both of the motors 16, 18 with the input of either one of the first and second control knobs 26, 28. Preferably, the jar sensor 30 is comprised of a magnetic, electrical or mechanical device to detect the presence of the jar 20 on the base 14 when the jar 20 is in the first operating configuration (FIG. 2). However, it is understood by those skilled in the art that the jar sensor 30 may be comprised of virtually any mechanism or device that can detect the presence of the jar 20 on top of the base 14.

Referring to FIGS. 1, 2 and 5, the jar 20 is sized and shaped to be removably mountable within the recess 80 in the top of the base 14 and for containing a relatively large amount of foodstuff. The jar 20 is generally ovular when viewed from above or below and includes a handle 42 on a side. The handle 42 may be permanently or removably attached to the jar 20. It is understood by those skilled in the art that the jar 20 of the present invention is not limited to the inclusion of a handle 42. Preferably, the handle 42 includes a recessed area 50 on an exterior lower surface. The jar 20 includes an upper open end 20a and a lower closed end 20b. The jar 20 and handle 42 are preferably formed of a high strength, light weight material, such as a polymeric material. However, it is understood by those skilled in the art that jar 20 and handle 42 may be formed of virtually any material, such as a metallic material or glass, without departing from the spirit and scope of the present invention.

Two blending collars 21a, 21b are removably mountable within the lower end 20b of the jar 20 to enclose the lower end 20b of the jar 20. The blending collars 21a, 21b maybe removably mountable on to the jar 20 in virtually any manner, such as by threaded engagement, adhesion, magnetism or by friction-fitting, without departing from the spirit and scope of the present invention. A first set of blending blades 46a extends from the top surface of the first blending collar 21a and a second set of blending blades 46b extends from the top surface of the second blending collar 21b. A conventional clutch (not shown) extends from the bottom surface of each blending collar 21a, 21b to matingly engage with the corresponding base clutches of the recessed area 80. Preferably, the two sets of blending blades 46a, 46b extend into the interior of the jar 20 when the collars 21a, 21b are removably mounted to the lower end 20b of the jar 20. The two sets of blending blades 46a, 46b include blades of varying size and shape to blend the foodstuff within the jar 20 as efficiently and as quickly as possible. Thus, the two sets of blending blades 46a, 46b are positioned in a spaced apart manner within an interior of the jar 20 when the blending blades 46a, 46b are positioned within the lower end 20b of the jar 20. When the jar 20 is positioned on the base 14, the first set of blending blades 46a is operatively connected to the first motor 16 and the second set of blending blades 46b is operatively connected to the second motor 18.

As seen in FIGS. 2 and 4, the first and second sets of blending blades 46a, 46b are generally vertically mounted on the blending collars 21a, 21b when the blending collars 21a, 21b are mounted within the lower end 20b of the jar 20. Thus, the drive shafts connected to the motor 16, 18, respectively, are vertically positioned within the base 14 of the mixing device 10. However, it is understood by those skilled in the art that the drive shafts and thus the first and second sets of blending blades 46a, 46b may be mounted at an angle within the base 14 to increase either the speed or the efficiency at which foodstuff is blended within the jar 20 or to change the consistency of the blended foodstuff within the jar 20.

As seen in FIGS. 1, 2 and 5, the jar 20 includes a lid 34 removably mountable to the upper open end or mouth 20a of the jar 20. The lid 34 may enclose either foodstuff within the jar or may enclose the at least one travel mug 22, 24 within the jar 20 when the at least one travel mug 22, 24 is mounted within the jar 20 for storage (FIG. 1). The lid 34 is generally ovular in shape when viewed from above and includes an opening 36. The opening 36 allows a user to pour contents from or into the jar 20 without having to remove the lid 34. The lid 34 further includes a plug or cap 38 removably engagable with the opening 36 to cover the opening 36 when the mixing device 10 is in the first operating configuration (FIG. 2). The lid 34 and cap 38 are preferably formed of a high strength, light weight material, such as a polymeric material. However, it is understood by those skilled in the art that the lid 34 and cap 38 may be formed of virtually any material, such as a metallic material, without departing from the spirit and scope of the present invention.

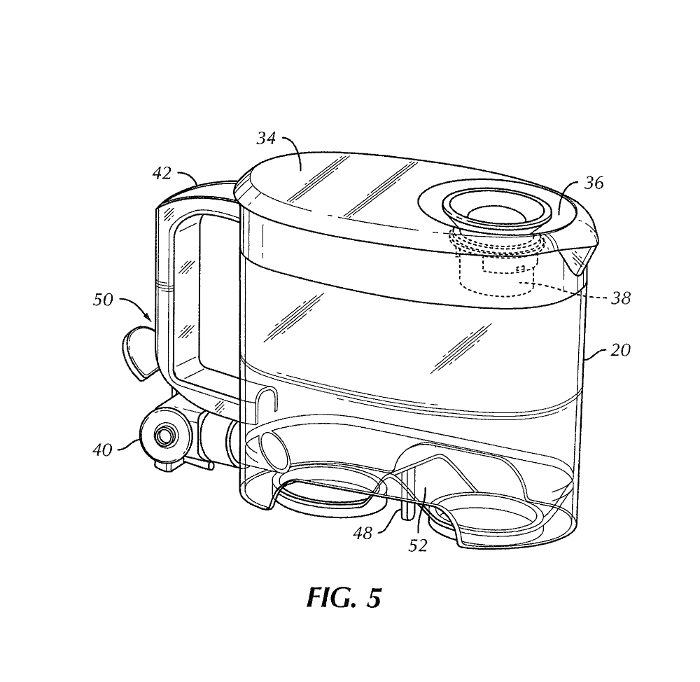

As seen in FIGS. 5 and 8, the interior surface of the jar 20 includes a ramp 52 positioned between the first set of blending blades 46a and the second set of blending blades 46b to maintain a quantity of foodstuff over the first and second set of blending blades 46a, 46b. The ramp 52 extends toward the interior of the jar 20 and is generally triangular in shape when viewed from the side. As a result, the ramp 52 has slanted opposed surfaces that are angled toward the first and second set of blending blades 46a, 46b, respectively. The ramp 52 urges blended foodstuff toward a dispensing spout 40 of the jar 20 to improve evacuation of blended foodstuff from within the jar 20. Without the use of the ramp 52 within the jar 20, foodstuff would tend to settle between the two sets of blending blades 46a, 46b and thus, foodstuff would not be quickly and efficiency blended within the jar 20. Further, as foodstuff is blended by the second set of blending blades 46b, foodstuff is projected upwardly toward the center of the jar 20. As the blended foodstuff then falls back toward the bottom of the interior of the jar 20, some of the blended foodstuff will fall on the ramp 52 and be sent toward the first set of blending blades 46a. This forced flow of the blended foodstuff helps to assure that the blended foodstuff is properly evacuated from within the jar 20. Although the triangular shape of the ramp 52 is preferred, it is understood by those skilled in the art that the ramp 52 may be modified in size, shape and orientation without departing from the spirit and scope of the present invention.

Further, as seen in FIGS. 5 and 8, a tab 48 may extend from the exterior of the bottom of the jar 20 opposite the ramp 52. The tab 48 may physically contact the jar sensor 30 of the base 14 to effectuate the operation of both motors 16, 18 with the input of only one control switch 26, 28. It is understood by those skilled in the art that the tab 48 would only extend from the jar 20 in the embodiment where the jar sensor 30 is comprised of a mechanical detection system. As is know by those of ordinary skill in the art, various alternative embodiments of the tab 48 may be necessary if the jar sensor 30 is comprised of a magnetic or electrical detection system, for example.

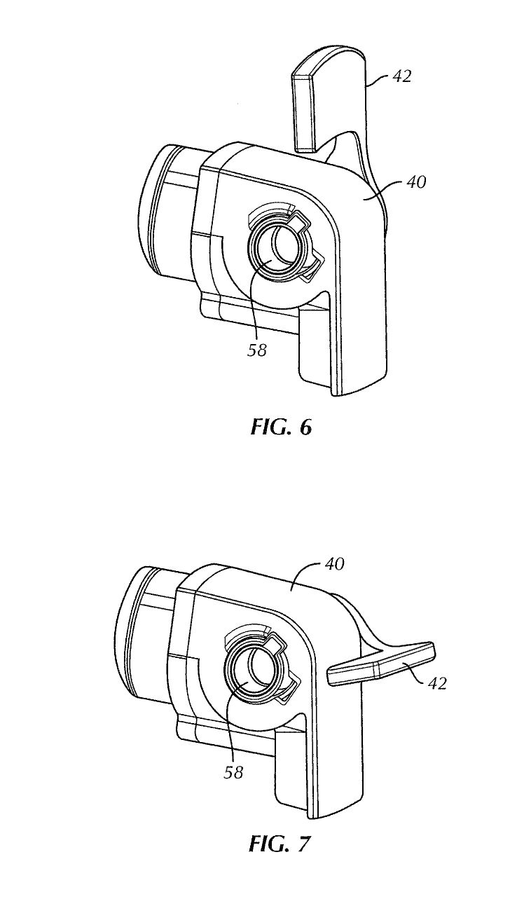

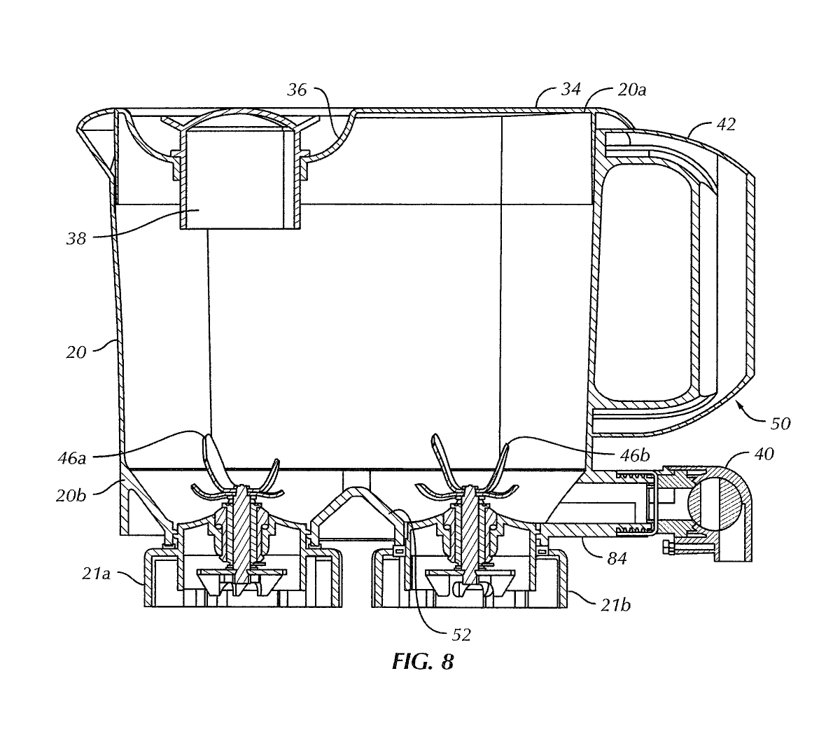

Referring to FIGS. 1, 2, and 5-8, the dispensing spout 40 is mounted to a dispensing tube 84 on side of the jar 20. The dispensing tube 84 is a passageway that connects the interior of the jar 20 to the external environment of the mixing device 10. The dispensing spout 40 allows a user to selectively release or prevent the release of contents from within the jar 20 out of the dispensing tube 84. Preferably, the dispensing spout 40 includes a valve 58, such as a gate, positioned therein and movable between a first position wherein foodstuff flows through the valve 58 (FIG. 6) and second position where foodstuff is prevented from flowing through the valve 58 (FIG. 7). However, it is understood by those skilled in the art that the dispensing spout 40 may include an mechanism that allows a user to selectively open or close the dispensing tube 84, such as a ball valve or a plunger-type valve, without departing from the spirit and scope of the present invention.

The dispensing spout 40 further includes a dispensing handle 42 secured to said valve 58 for moving the valve 58 between the first and second positions. As seen in FIGS. 1 and 2, when the valve 58 is the in first position (FIG. 6), the dispensing handle 42 is accommodated in the recessed area 50 of the jar handle 42. The recessed area 50 of the jar handle 42 provides space so that the valve 58 may be fully closed within in the dispensing spout 40 and allows room for a users hand or fingers to manipulate the handle 42 away from the jar 20 so that the valve 58 can be moved towards the open position (FIG. 7). The specific operation of the valve 58 is well known to those of ordinary skill in the art.

Although the dispensing spout 42 of the present application is preferably permanently mounted to the dispensing tube 84 of the jar 20, it is understood by those skilled in the art that the dispensing spout 40 may be removably mounted to the dispensing tube 84. The dispensing spout 40 may include a fastening mechanism (not shown) that mates with locking keys (not shown) on the exterior periphery of the dispensing tube 84 which extends from the jar 20. Alternatively, the dispensing spout 42 may be threadingly engagable to the dispensing tube 84 (see FIG. 8).

Referring to FIGS. 1 and 3, the mixing device 10 includes the at least one travel mug 22, 24 for containing foodstuff therein. The at least one travel mug 22, 24 allows a user to blend smaller amounts of foodstuff than those typically used with the larger jar 20. Preferably the at least one travel mug 22, 24 is comprised of a first travel mug 22 and a second travel mug 24 which are each independently and separately mountable and operable on the base 12. Specifically, the blending collars 21a, 21b used to enclose the lower end 20b of the jar 20 are also removably mountable within a lower ends of the first and second travel mugs 22, 24, respectively, to enclose the lower ends of the first and second travel mugs 22, 24, respectively. Similarly to their use with the jar 20, the blending collars 21a, 21b are removably mountable to the first and second travel mugs 22, 24, respectively, by virtually any manner, such as by one or more screws (not shown). Thus, the blending collars 21a, 21b may be used on both the jar 20 and either of the travel mugs 22, 24.

Although the use of one or two travel mugs is presently preferred, it is understood by those skilled in the art that the mixing device 10 may accommodate more than two travel mugs without departing from the spirit and scope of the present invention. The travel mugs 22, 24 are adapted for being transported with the user in a drinking configuration and for mounting to the base 14 of the mixing device 10 in a blending configuration (FIG. 3). The travel mugs 22, 24 each include a cup body having an open top, an open bottom and a cavity therein. The cup body 14 is preferably generally tubular and formed of a high strength, light weight insulating material, such as a polymeric material. The bottom of the cup body includes outer threads (not shown) on an exterior surface of the cup body. Further, inner threads (not shown) may be located on an interior surface of the bottom of the cup body. Thus, the blending collars 20a, 20b are removably mountable to the bottom of the cup bodies of the travel mugs 22, 24 to enclose and properly secure the first and second set of blending blades 46a, 46b to the cup bodies.

Each travel mug 22, 24 preferably includes a drinking cap 22a, 24a that is removably mounted to the top of the cup body. The drinking caps 22a, 24a are preferably circular when viewed from above and formed to engage the circular top of the cup body 14. It is understood by those skilled in the art that the present application is not limited to the specific structure described above for the travel mugs 22, 24. Virtually any portable container or cup may be used to be removably mountable to the base 14 of the mixing device 10. Preferably, as shown in FIG. 1, the travel mugs 22, 24 are sized and shaped to fit within the jar 20 when the mixing device 10 is not being used to reduce the overall size of the mixing device for storage purposes.

In operation, the user places the base 14 onto the support surface, such as the countertop or tabletop, so that the base support 12 is flush with the support surface to provide stability to the mixing device 10. Next, the user operatively connects the power cord of the base 14 to an electrical outlet in a conventional manner. At this point, the user has the option of using the relatively large container (i.e. the jar 20) or the at least one smaller container (i.e. the at least one travel mug 22, 24). If the user desires that the blending operation requires the relatively large jar 20, the user mounts the blending collars 21a, 21b into the lower open end 20b of the jar 20 in a manner as described in detail above. Once the lower end 20b of the jar 20 is enclosed by the blending collars 21a, 21b, the jar 20 can be mounted within the recess 80 of the blender 14 to operatively connect the conventional clutches of the blending collars 21a, 21b to the clutches extending upwardly from the recess 80 of the base 14. The conventional clutches of the blending collars 21a, 21b and the clutches of the recess 80 matingly engage to ensure that the blending blades 46a, 46b can be properly controlled by operation of the first and second motors 16, 18.

Next, the user must ensure that the dispensing handle 42 of the dispensing spout 40 is in the closed position (FIG. 6) to ensure that foodstuff does not inadvertently flow out of the dispensing tube 84 during operation of the first and second motors 16, 18. Next the user inserts the desired amount or type of foodstuff into the jar 20 and places the lid 34 and cap 38 on top of the jar 20 to completely enclose the foodstuff within the jar 20. Next, the user rotates either one of the control switches 26, 28 to begin rotation of the blending blades 46a, 46b by the motors 16, 18. In the present configuration, the jar sensor 30 of the base 14 detects the presence of the jar 20 and allows both motors 16, 18 to be actuated with the input of either one of the control switches 26, 28.

During operation of the motors 16, 18 in the present configuration, the ramp 52 within the jar 20 assures that the foodstuff is being efficiently and evenly blended. When the user determines that the foodstuff has been blended to a proper consistency, the user can pivot the dispensing handle 42 to the open position (FIG. 7) such that the blended foodstuff can flow from within the jar 20 to the external environment of the mixing device 10 via the dispensing tube 84. The dispensing spout 40 can be opened when the motors 16, 18 have been turned off by one of the control switches 26, 28 or when the motors 16, 18 are still operating. As is understood by those skilled in the art, the ramp 52 helps to ensure that the blended foodstuff flows out of the dispensing spout 40 when the motors 16, 18 are operating. If the user desires to pour the blended contents out of the jar 20 instead of using the dispensing spout 40, the user must turn either one of the control switches 26, 28 to an off position to cut power to the motors 16, 18. Then, the user may lift the jar 20 from the base 14 via the jar handle 42, remove either the lid 34 from the upper end 20a or the cap 38 from the opening and tilt the jar 20 to pour the blended foodstuff out of the jar 20.

Alternatively, if the user determines that a smaller amount of foodstuff will be blended, the user may choose to blend foodstuff within either or both of the travel mugs 22, 24. In this configuration, the users will mount the blending collars 21a, 21b to the lower ends of the travel mugs 22, 24, respectively, as was described above. Once each blending collar 21a, 21b is properly attached to a travel mug 22, 24, the user would set the combined travel mugs 22, 24 and blending collars 21a, 21b onto the top of the base 14 such that the conventional clutches on the bottom of the blending collars 21a, 21b matingly engage the clutches within the recess 80 of the base 14. In this configuration, since the jar sensor 30 would not detect the presence of the jar 20, each motor 16, 18 must be separately and independently operated by its respective control switch 26, 28.

Once the user determines that the foodstuff within the travel mugs 22, 24 has been properly blended, the user rotates the control switches 26, 28 to cut power to the motors 16, 18, respectively. Then, the user would vertically remove each travel mug 22, 24 from within the recess 80 of the base 14. Next, each travel mug 22, 24 may be inverted such that the blending collars 21a, 21b can be removed from the bottoms of the travel mugs 22, 24. It is important for the user to check that the drinking cap 22a, 24a of each travel mug 22, 24, properly enclose the upper open end 20a of the cup bodies before the user inverts the travel mugs 22, 24. The user then removes the blending collars 21a, 21b from the travel mugs 22, 24 and encloses the lower open end 20b of the cup bodies with a cup base (not shown), as is known by those of ordinary skill in the art. Then, the travel mugs 22, 24 may be inverted once again into the normal upright position and may be carried or transported by the user or consumer.

It will be appreciated by those skilled in the art that changes could be made to the embodiment described above without departing from the broad inventive concept thereof. It is understood, therefore, that this invention is not limited to the particular embodiment disclosed, but is intended to cover modifications within the spirit and scope of the present invention as defined by the appended claims.

I claim:

1. A mixing device configured to blend foodstuff, said device comprising:
a base housing at least one motor;
a jar for containing said foodstuff, said mixing device having a first operating configuration wherein said foodstuff is blended within said jar; and
at least one travel mug for containing said foodstuff, said mixing device having a second operating configuration wherein said foodstuff is mixed within said at least one travel mug;
wherein said jar and said at least one travel mug are separately removably mountable to said base, and wherein said at least one travel mug is removably mountable within said jar for storage.

2. A device in accordance with claim 1, further comprising:
a lid removably mountable to a mouth of said jar; wherein said lid encloses said at least one travel mug within said jar when said at least one travel mug is mounted within said jar.

3. A device in accordance with claim 1, further comprising:
a dispensing spout mounted to said jar, said dispensing spout including a valve positioned therein and movable between a first position wherein food flows through said valve and a second position wherein foodstuff is prevented from flowing through said valve.

4. A device in accordance with claim 3, further including a dispensing handle secured to said valve for moving said valve between said first and second positions.

5. A device in accordance with claim 1, wherein said at least one motor is comprised of a first motor and a second motor capable of being separately operable by a first control knob and a second control knob, respectively.

6. A device in accordance with claim 5, said base includes a jar sensor to detect the presence of the jar in the first operating configuration, wherein said jar sensor detects a presence of said jar on said base to enable actuation of each of said motors with the input of either one of said first and second control knobs.

7. A device in accordance with claim 1, wherein said at least one travel mug is comprised of a first and a second travel mug which are each independently and separately mountable and operable on said base.

8. A mixing device configured to blend foodstuff, said device comprising:
a base having first and second motors capable of being separately operable by first and second control knobs, respectively, said base further including a jar sensor; and
a jar removably mountable to said base for containing said foodstuff;
wherein said jar sensor detects a presence of said jar on said base to enable actuation of each of said motors with the input of either of said first control knob or said second control knob.

9. A device in accordance with claim 8, further comprising:
at least one travel mug for containing said foodstuff;
wherein said jar and said at least one travel mug are separately removably mountable to said base for blending said foodstuff therein, and wherein said at least one travel mug is removably mountable within said jar for storage.

10. A device in accordance with claim 9, further comprising:
a lid removably mountable to a mouth of said jar, wherein said lid encloses said at least one travel mug within said jar when said travel mug is mounted within said jar.

11. A device in accordance with claim 8, further comprising:
a dispensing spout mounted to said jar, said dispensing spout including a valve positioned therein and movable between a first position wherein food flows through said valve and a second position wherein food is prevented from flowing through said valve.

12. A device in accordance with claim 11, further including a dispensing handle secured to said valve for moving said gate valve between said first and second positions.

13. A device in accordance with claim 10, wherein said mixing device has a first operating configuration wherein said foodstuff is blended within said jar and a second operating configuration wherein said foodstuff is blended within said at least one travel mug.

14. A device in accordance with claim 13, said lid defining an opening, said lid including a cap removably engageable within said opening to cover said opening when said mixing device is in said first operating configuration.

15. A mixing device configured to blend foodstuff, said device comprising:
a base housing a first and a second motor;
a jar for containing said foodstuff, said jar having a first set of blending blades and a second set of blending blades spaced apart from said first set of blending blades within an interior of said jar to blend said foodstuff, said first set of blending blades operatively connected to said first motor and said second set of blending blades operatively connected to said second motor when said jar is mounted to said base;
wherein a ramp is positioned between said first set of blending blades and said second set of blending blades within said interior of said jar to maintain a quantity of foodstuff over said first and second set of blending blades.

16. A device in accordance with claim 15, further comprising:
a dispensing spout mounted to said jar, said dispensing spout including a valve positioned therein and movable between a first position wherein food flows through said valve and a second position wherein food is prevented from flowing through said valve;
wherein said ramp urges blended foodstuff towards said dispensing spout to improve evacuation of blended foodstuff from within said jar.
